(19) United States
(12) Patent Application Publication
(10) Pub. No.: US 2014/0241498 A1
(43) Pub. Date: Aug. 28, 2014

(54) X-RAY IMAGING SYSTEM INCLUDING FLAT PANEL TYPE X-RAY GENERATOR, X-RAY GENERATOR, AND ELECTRON EMISSION DEVICE

(71) Applicant: Samsung Electronics Co., Ltd., Suwon-si (KR)

(72) Inventors: Tae-won JEONG, Yongin-si (KR); Yong-chul KIM, Seoul (KR); Il-hwan KIM, Seoul (KR); Do-yoon KIM, Hwaseong-si (KR); Shang-hyeun PARK, Yongin-si (KR)

(73) Assignee: Samsung Electronics Co., Ltd., Suwon-si (KR)

(21) Appl. No.: 14/132,505

(22) Filed: Dec. 18, 2013

(30) Foreign Application Priority Data
Feb. 26, 2013 (KR) 10-2013-0020659

(51) Int. Cl. G01N 23/083; H01J 35/04; H05G 1/02

(52) U.S. Cl. CPC G01N 23/083; H05G 1/02; H01J 35/045
USPC 378/62; 378/121; 313/301

(57) ABSTRACT

An X-ray imaging system includes an X-ray generator including a plurality of X-ray generation units, where the plurality of X-ray generation units is two-dimensionally arranged, and operates independently of each other; and an X-ray detector spaced apart from the X-ray generator, where the X-ray detector includes a plurality of X-ray detection units corresponding to the plurality of X-ray generation units, where a space is defined between the X-ray generator and the X-ray detector.

### CROSS-REFERENCE TO RELATED APPLICATIONS

This application claims priority to Korean Patent Application No. 10-2013-0020659, filed on Feb. 26, 2013, and all the benefits accruing therefrom under 35 U.S.C. §119, the content of which in its entirety is herein incorporated by reference.

### BACKGROUND

1. Field

The disclosure relates to an X-ray imaging system including a flat panel type X-ray generator, an X-ray generator and an electron emission device.

2. Description of the Related Art

X-rays are widely used in non-destructive testing, structural and physical properties testing, image diagnosis, security inspection, and the like, in the fields of industry, science, medical treatment, etc. Generally, an imaging system using X-rays for such purposes includes an X-ray generator for radiating an X-ray and an X-ray detector for detecting the X-ray that have passed through an object.

In recent, the X-ray detector using a digitalization method is widely used, and an X-ray generator typically uses an electron generation device using a tungsten filament type cathode. In such an X-ray generator, a single electron generation device is typically mounted in a single X-ray photographing device. When a flat panel type X-ray detector is used, the X-ray generator and an object to be tested may be disposed with a predetermined distance therebetween to obtain an image from the single electron generation device.

### SUMMARY

Provided are an X-ray imaging systems including a flat panel type X-ray generator, the X-ray generator, and an electron emission device in the X-ray generator.

Additional features will be set forth in part in the description which follows and, in part, will be apparent from the description, or may be learned by practice of the presented embodiments.

According to an embodiment of the invention, an X-ray imaging system includes an X-ray generator including a plurality of X-ray generation units, where the plurality of X-ray generation units is two-dimensionally arranged, and operates independently of each other; and an X-ray detector spaced apart from the X-ray generator, where the X-ray detector includes a plurality of X-ray detection units corresponding to the plurality of X-ray generation units, where a space is defined between the X-ray generator and the X-ray detector.

In an embodiment, the space between the X-ray generator and the X-ray detector may be defined by at least one of the X-ray generator and the X-ray detector.

In an embodiment, an X-ray generated from a portion of the plurality of X-ray generation units may be irradiated into a specific region of the space between the X-ray generator and the X-ray detector.

In an embodiment, when the X-ray is irradiated into the specific region of the space, a portion of the plurality of X-ray detection units corresponding to the portion of the plurality of X-ray generation units may be driven.

In an embodiment, the portion of the plurality of X-ray generation units may be simultaneously or sequentially driven.

In an embodiment, an area of the plurality of X-ray generation units may be substantially equal to or greater than an area of the plurality of X-ray detection units.

In an embodiment, the X-ray generator may further include a collimator disposed between the X-ray generation units and the X-ray detector, where the collimator may adjust a direction of an X-ray generated from the X-ray generation units.

In an embodiment, the plurality of X-ray generation units may include a plurality of electron emission units which emit electrons, and a plurality of X-ray emission units which emit the X-ray by the electrons emitted from the plurality of electron emission units.

In an embodiment, the X-ray generator may further include an electron emission device including the plurality of electron emission units and an X-ray emission device including the plurality of X-ray emission units.

In an embodiment, each of the plurality of electron emission units may include: a cathode electrode; a gate electrode spaced apart from the cathode electrode, where the gate electrode may include: a first gate including a mesh portion and an extension portion disposed around the mesh portion; and a second gate disposed on the extension portion of the first gate, where a gate hole, which exposes the mesh portion, is defined in the second gate; a gate insulating layer disposed between the cathode electrode and the gate electrode, where the gate insulating layer may include: a plurality of first support portions which supports the mesh portion; and a second support portion which supports the extension portion; and a plurality of electron emission sources disposed on a portion of the cathode electrode exposed by the gate insulating layer.

In an embodiment, the gate hole may have a cross-sectional area decreasing toward the first gate.

In an embodiment, the X-ray imaging system may further include: a focusing electrode disposed on the gate electrode and spaced part from the gate electrode.

In an embodiment, the first and second gates may be electrically connected to each other.

In an embodiment, a grid interval of the mesh portion may be substantially equal to or less than a height of the first support portions.

In an embodiment, the plurality of first support portions may be disposed on the cathode electrode in a stripe shape, and the plurality of electron emission sources may be disposed between adjacent first support portions of the plurality of first support portions in the stripe shape or between the first and second support portions.

In an embodiment, a height of the plurality of electron emission sources may be lower than a height of the gate insulating layer.

In an embodiment, the plurality of X-ray emission units may include an anode electrode which generates the X-ray by the electrons emitted from the plurality of electron emission sources.

In an embodiment, the plurality of X-ray emission units may further include a shield window disposed on the anode electrode and which blocks the X-ray.

According to another embodiment of the invention, an X-ray generator includes: a plurality of X-ray generation units which is two-dimensionally arranged and operates independently of each other, where the plurality of X-ray generation units include: a plurality of electron emission units which emits electrons; and a plurality of X-ray emission units which emit an X-ray by the electrons emitted from the plurality of electron emission units, where each of the plurality of electron emission units includes: a cathode electrode; a gate electrode spaced apart from the cathode electrode, where the gate electrode includes: a first gate including a mesh portion and an extension portion disposed around the mesh portion; and a second gate disposed on the extension portion of the first gate, where a gate hole, which exposes the mesh portion, is defined in the second gate; a gate insulating layer disposed between the cathode electrode and the gate electrode, where the gate insulating layer includes: a plurality of first support portions which supports the mesh portion; and a second support portion which supports the extension portion; and a plurality of electron emission sources disposed on a portion of the cathode electrode exposed by the gate insulating layer.

According to another embodiment of the invention, an electron emission device includes: a plurality of electron emission units which is two-dimensionally arranged and operates independently of each other, where each of the plurality of electron emission units includes: a cathode electrode; a gate electrode spaced apart from the cathode electrode, where the gate electrode includes: a first gate including a mesh portion and an extension portion disposed around the mesh portion; and a second gate disposed on the extension portion of the first gate, a gate hole, which exposes the mesh portion, is defined in the second gate; a gate insulating layer disposed between the cathode electrode and the gate electrode, where the gate insulating layer includes: a plurality of first support portions which supports the mesh portion; and a second support portion which supports the extension portion; and a plurality of electron emission sources disposed on a portion of the cathode electrode exposed by the gate insulating layer.

### BRIEF DESCRIPTION OF THE DRAWINGS

The above and other features of the invention will become more apparent by describing in further detail exemplary embodiments thereof with reference to the accompanying drawings, in which:

FIG. 1 is a perspective view of an embodiment of an X-ray imaging system;

FIG. 2 is a cross-sectional view of the X-ray imaging system of FIG. 1;

FIG. 3 is a plan view of an embodiment of an electron emission device of FIG. 1,

FIG. 4 is a plan view of an embodiment of an X-ray detector of FIG. 1;

FIG. 5 is a cross-sectional view taken along line V-V′ of FIG. 3;

FIG. 6 is a cross-sectional view taken along line VI-VI′ of FIG. 3;

FIG. 7 is an enlarged view of a portion A of FIG. 3;

FIG. 8 is a cross-sectional view taken along line VIII-VIII′ of FIG. 7;

FIG. 9 is a perspective view of a gate insulating layer and electron emission sources on cathode electrodes;

FIG. 10 shows alternative embodiment of an X-ray emission device of FIG. 1;

FIG. 11 is a view showing a specific region of an object photographed using the X-ray imaging system of FIG. 1;

FIG. 12 is a view showing a specific region of an object 3-dimensionally photographed using the X-ray imaging system of FIG. 1;

FIG. 13 shows another embodiment of an X-ray imaging system; and

FIG. 14 shows another embodiment of a reflective type X-ray imaging system.

### DETAILED DESCRIPTION

The invention will be described more fully hereinafter with reference to the accompanying drawings, in which embodiments of the invention are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element or layer is referred to as being “on,” “connected to” or “coupled to” another element or layer, the element or layer can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the claims set forth herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, embodiments of the invention will be described in further detail with reference to the accompanying drawings.

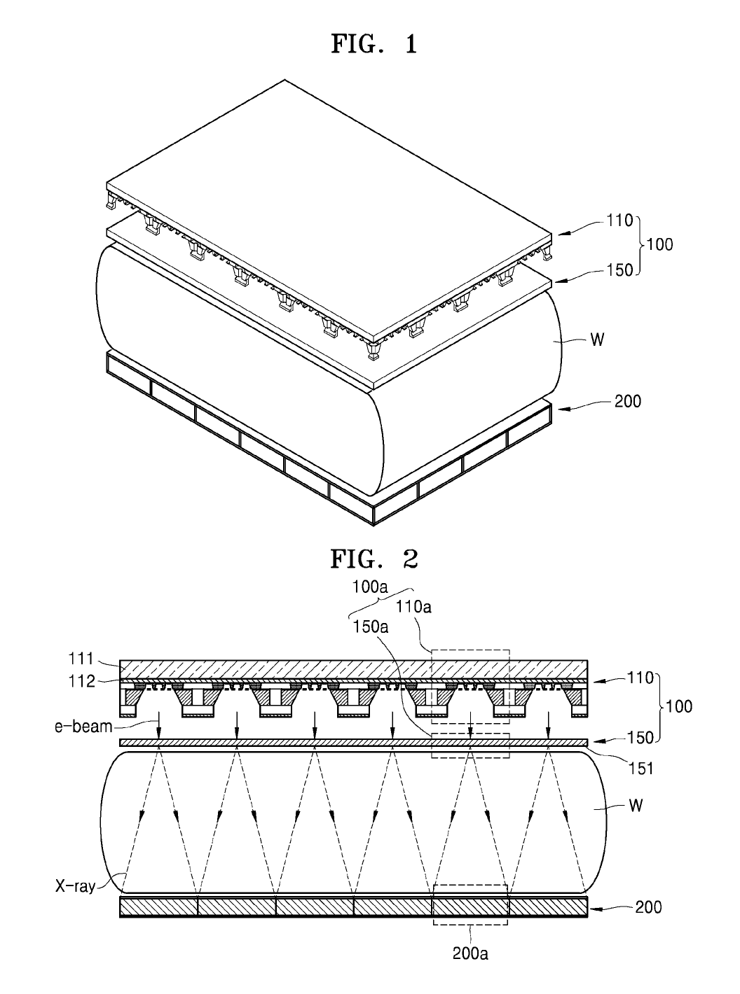

FIG. 1 is a perspective view of an embodiment of an X-ray imaging system, and FIG. 2 is a cross-sectional view of the X-ray imaging system of FIG. 1.

In an embodiment, as shown in FIGS. 1 and 2, an X-ray imaging system may be a transparent type X-ray imaging system. Referring to FIGS. 1 and 2, an embodiment of the X-ray imaging system includes an X-ray generator (e.g., a flat type X-ray generator) 100 and an X-ray detector 200 that detects an X-ray generated by the X-ray generator 100. In such an embodiment, the X-ray generator 100 and the X-ray detector 200 are spaced apart from each other such that a space is defined in between the X-ray generator 100 and the X-ray detector 200. An object W is disposed in the space between the X-ray generator 100 and the X-ray detector 200. In an embodiment, the object W may be defined as a space between the X-ray generator 100 and the X-ray detector 200, and another object or a sample to be photographed, tested or inspected may be disposed inside the object W. In one embodiment, for example, the object W may be a transparent container for receiving another object or a sample. The X-ray detector 200 detects an X-ray that is emitted from the X-ray generator 100 and transmitted to the object W such that an inside of the object W is photographed. In an embodiment, the object W may be disposed or defined in the space between the X-ray generator 100 and the X-ray detector 200 to contact the X-ray generator 100 or the X-ray detector 200. In one embodiment, for example, the object W may be disposed or defined in the space between the X-ray generator 100 and the X-ray detector 200 to contact the X-ray generator 100 and the X-ray detector 200.

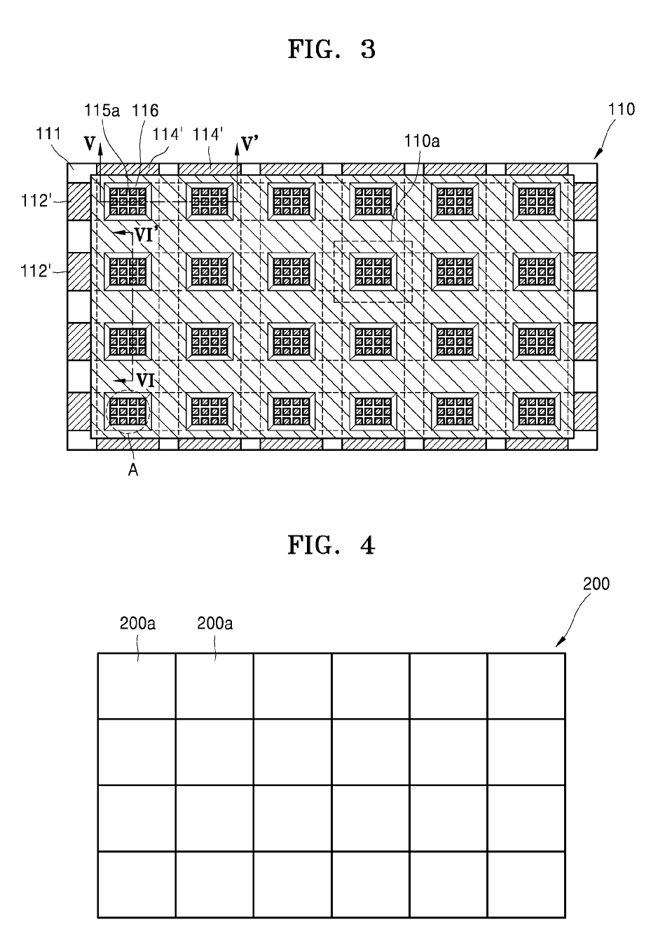

The X-ray generator 100 includes a plurality of X-ray generation units 100a. In an embodiment, the plurality of X-ray generation units 100a may be two-dimensionally arranged on a surface of the X-ray generator 100 and may operate independently of each other. In an embodiment, the plurality of X-ray generation units 100a may be two-dimensionally arranged substantially in a matrix form, as shown in FIG. 3. The plurality of X-ray generation units 100a include a plurality of electron emission units 110a, which may emit electrons independently of each other, and a plurality of X-ray emission units 150a, which emits the X-ray by the electrons emitted from the electron emission units 110a. In an embodiment, the electron emission units 110a are disposed in an electron emission device 110, and the X-ray emission units 150a are disposed in an X-ray emission device 150. In such an embodiment, the X-ray generator 100 may include the electron emission device 110 including the plurality of electron emission units 110a, and the X-ray emission device 150 including the plurality of X-ray emission units 150a.

The X-ray emission device 150 includes an anode electrode 151 that emits the X-ray by the electrons emitted from the electron emission device 110. The anode electrode 151 may include, for example, a metal such as W, Mo, Ag, Cr, Fe and Cu, for example, or a metal alloy thereof. The anode electrode 151 may be integrally manufactured, e.g., provided as a single unitary indivisible part, or may be manufactured as being separated into a plurality of anode electrode parts corresponding to the electron emission units 110a, respectively. In an embodiment, the X-ray emission device may further include a substrate (not shown), for example, a glass substrate, through which the X-ray may transmit, and 150 the anode electrode 151 may be disposed on the substrate. The X-ray emission device 150 of the transparent type X-ray imaging system may transmit the X-ray. In an embodiment, the object W may be disposed between the X-ray emission device 150 and the X-ray detector 200. The object W may be disposed to contact at least one of the X-ray emission device 150 and the X-ray detector 200. The X-ray detector 200 includes a plurality of X-ray detection units 200a that may be 2-dimensionally arranged and independently driven. In an embodiment, the plurality of X-ray detection units 200a may be arranged to correspond to the plurality of X-ray generation units 100a, respectively.

In one embodiment, for example, the X-ray generation units 100a and the X-ray detection units 200a may be in a one-to-one correspondence with each other. In an alternative embodiment, each of the X-ray generation units 100a may correspond to two or more of the X-ray detection units 200a, each of the X-ray detection units 200a may correspond to two or more of the X-ray generation units 100a, or each of two or more of the X-ray detection units 200a may correspond to two or more of the X-ray generation units 100a. An embodiment, where the X-ray generation units 100a and the X-ray detection units 200a are in a one-to-one correspondence with each other, is shown in FIG. 2. In such an embodiment, as shown in FIG. 2, an area of the X-ray generation units 100a may be substantially equal to an area of the X-ray detection units 200a. In an alternative embodiment, the area of the X-ray generation units 100a may be greater than the area of the X-ray detection units 200a.

In an embodiment, the X-ray generation units 100a may operates independently of each other to generate the X-ray. In such an embodiment, all of the X-ray generation units 100a may be driven to irradiate the X-ray to substantially an entire region of the object W or a portion of the X-ray generation units 100a may be driven to irradiate the X-ray to a specific region (e.g., a predetermined portion) of the object W. In such an embodiment, at least one of the X-ray generation units 100a may be driven to irradiate the X-ray to substantially the entire region of the object W or the specific region thereof. In such an embodiment, only X-ray detection units 200a corresponding to the driven X-ray generation units 100a among the X-ray detection units 200a may be driven. In an embodiment, a portion of the X-ray generation units 100a may be simultaneously or sequentially driven. In one embodiment, for example, all of the X-ray generation units 100a may be simultaneously driven to irradiate the X-ray to the overall region of the object W, as shown in FIG. 2. In an alternative embodiment, although not shown in FIGS. 1 and 2, a collimater 300 (shown in FIG. 12), which adjusts a direction of the X-ray, may be further disposed between the X-ray generator 100 and the X-ray detector 200.

FIG. 3 is a plan view of an embodiment of the electron emission device 110 of FIG. 1.

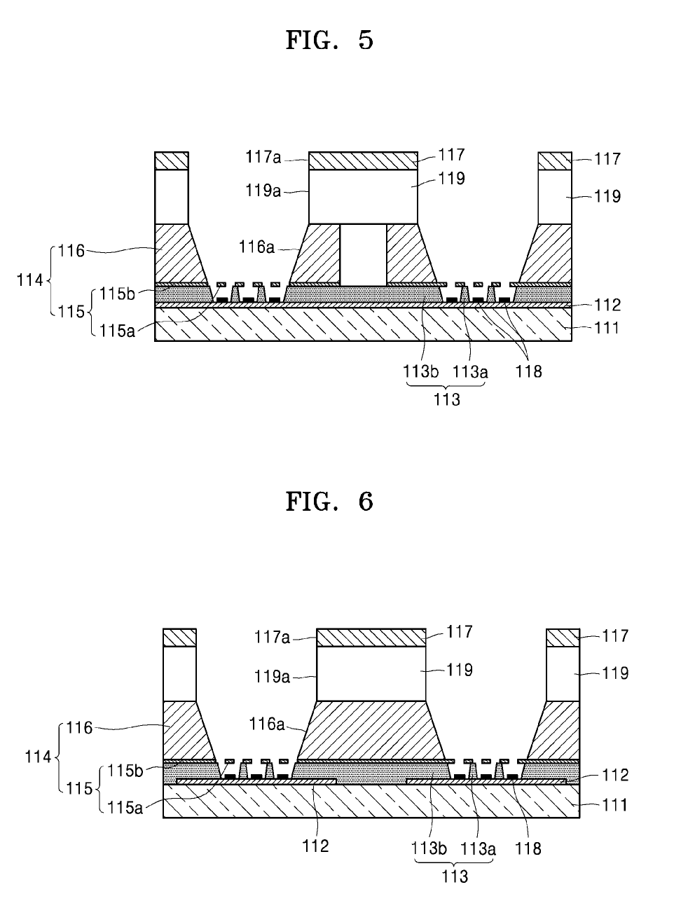

Referring to FIG. 3, an embodiment of the electron emission device 110 include a substrate 111, and a plurality of cathode electrodes 112 (shown in FIG. 5), to which voltages are applied through a plurality of cathode lines 112′, are disposed on the substrate 111. In an embodiment, the cathode electrodes 112 may extend substantially in a first direction D1, and may be arranged substantially parallel to each other. A plurality of gate electrodes 114, to which voltages are applied through a plurality of gate lines 114′, is disposed on upper portions of the cathode electrodes 112. In an embodiment, the gate electrodes 114 may extend in a second direction D2 crossing the cathode electrodes 112. The electron emission units 110a are disposed on the substrate 110 in overlapping regions of the cathode electrodes 112 and the gate electrodes 114, e.g., a portion in which the cathode electrodes 112 and the gate electrodes 114 cross to each other. Thus, the electron emission units 110a may be two-dimensionally arranged on the substrate 111 substantially in a two-dimensional matrix form. In such an embodiment, the electron emission units 110a may be arranged in the form of an m×n matrix (here, m and n are integers equal to or greater than 2). In an embodiment, the electron emission units 110a may be arranged in the form of a 6×4 matrix, as shown in FIG. 3. The two-dimensionally arranged electron emission units 110a may operate independently of each other to emit electrons. In such an embodiment, when a predetermined voltage is applied to each of one of the cathode electrodes 112 and one of the gate electrodes 114, the electron emission unit 110a disposed in the overlapping region of the cathode electrode 112 and the gate electrode 114 may be driven to emit electrons.

FIG. 4 is a plan view of an embodiment of the X-ray detector 200 of FIG. 1.

Referring to FIG. 4, the X-ray detector 200 may include the plurality of X-ray detection units 200a that are two-dimensionally arranged. In an embodiment, the X-ray detection units 200a may be arranged to correspond to the X-ray generation units 100a. In one embodiment, the X-ray generation units 100a and the X-ray detection units 200a may be arranged in a one-to-one correspondence with each other. In an alternative embodiment, each of the X-ray generation units 100a may be provided to correspond to two or more of the X-ray detection units 200a, or each of the X-ray detection units 200a may be provided to correspond to two or more of the X-ray generation units 100a. In one embodiment, for example, the X-ray detection units 200a are arranged in the 6×4 matrix, and in a one-to-one correspondence with the X-ray generation units 100a shown in FIG. 3, as shown in FIG. 4.

Hereinafter, the electron emission units 110a will now be described in greater detail with reference to FIGS. 5 through 8.

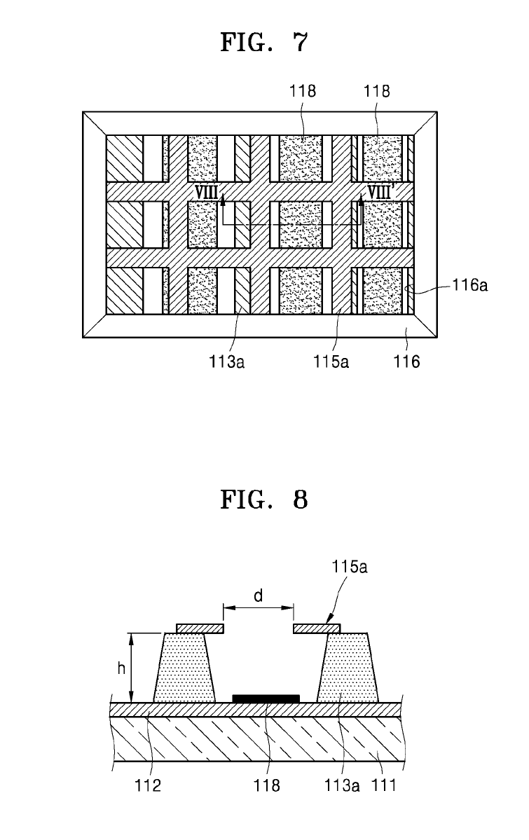

FIG. 5 is a cross-sectional view taken along line V-V′ of FIG. 3. FIG. 6 is a cross-sectional view taken along line Vi-VI′ of FIG. 3. FIG. 7 is an enlarged view of a part A of FIG. 3. FIG. 8 is a cross-sectional view taken along line VIII-VIII′ of FIG. 7.

Referring to FIGS. 5 through 8, the cathode electrodes 112 are disposed on the substrate 111. In an embodiment, the substrate 111 may be an insulating substrate such as a glass substrate, for example, but the invention is not limited thereto. In an alternative embodiment, the substrate 100 may be a conductive substrate. In such an embodiment, an insulating layer (not shown) may be disposed on a surface of the conductive substrate. The cathode electrodes 112 may include a conductive material. In one embodiment, for example, the cathode electrodes 112 may include a metal or a conductive metal oxide. In such an embodiment, the cathode electrodes 112 may include a metal such as Ti, Pt, Ru, Au, AG, Mo, Al, W, or Cu, for example, or a metal oxide such as indium tin oxide (“ITO”), aluminum zinc oxide (“AZO”), indium zinc oxide (“IZO”), SnO₂, or In₂O₃, for example, but not being limited thereto. In an alternative embodiment, the cathode electrodes 112 may include other various materials.

In an embodiment, as shown in FIGS. 5 and 6, a gate insulating layer 113 is disposed on the cathode electrodes 112. The gate electrodes 114 including first and second gates 115 and 116 are disposed on the gate insulating layer 113. The gate insulating layer 113 insulates the cathode electrodes 112 and the gate electrodes 114 from each other, and supports the gate electrodes 114. In an embodiment, as shown in FIGS. 5 and 6, the gate insulating layer 113 may include a plurality of first support portions 113a that support a mesh portion 115a of the first gate 115 and a second support portion 113b that supports an extension portion 115b of the first gate 115 and the second gate 116. The gate insulating layer 113 may include, for example, SiO₂, Si₃N₄, HfO₂, Al₂O₃, or a combination thereof, but not being limited thereto. A plurality of electron emission sources 118 may be disposed on a portion of the cathode electrodes 112, which is exposed through the gate insulating layer 113. In such an embodiment, the electron emission sources 118 may be disposed on a portion of the cathode electrodes 112 between the first and second support portions 113a and 113b. The electron emission sources 118 emit electrons when voltages are applied between the cathode electrodes 112 and the gate electrodes 114. The electron emission sources 118 may include, for example, a carbon nanotube (“CNT”), a carbon nanofiber, a metal, silicon, an oxide, diamond, a diamond like carbon (“DLC”), a carbide compound, a nitrogen compound, or a combination thereof. However, the invention is not limited thereto. The electron emission sources 118 may have a height lower than a height h the gate insulating layer 113, as shown in FIG. 8.

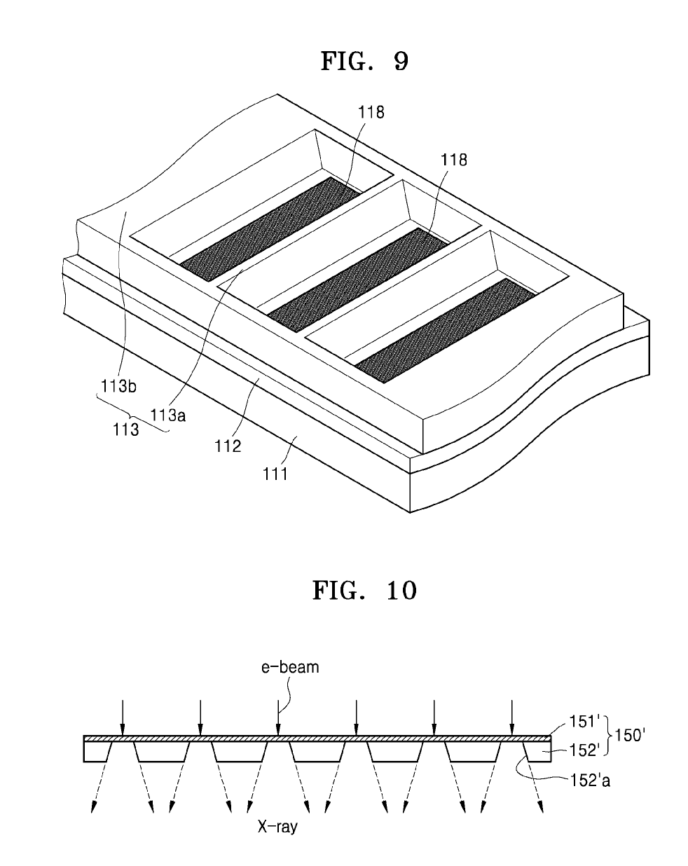

FIG. 9 is a perspective view of an embodiment of the gate insulating layer 113 and the electron emission sources 118 disposed on the cathode electrodes 112. Referring to FIG. 9, the first support portions 113a of the gate insulating layer 113 may be disposed on the cathode electrodes 112 in a stripe shape and be substantially parallel to each other. The electron emission sources 118 are disposed between adjacent first support portions 113a or between adjacent first and second support portions 113a and 113b. In an embodiment, the electron emission sources 118 may collectively define the stripe shape, but not being limited thereto. In an alternative embodiment, the first support bars 113a and the electron emission sources 118 may have various shapes other than the stripe shape.

Referring back to FIGS. 5 and 6, the gate electrodes 114 are disposed on the gate insulating layer 113. The gate electrodes 114 may include a conductive material, e.g., a material substantially the same as the material of the cathode electrodes 112. In one embodiment, for example, the gate electrodes 114 may include a metal or a conductive metal oxide. The gate electrodes 114 include the first and second gates 115 and 116 sequentially disposed, e.g., stacked, on the gate insulating layer 113. In such an embodiment, the first and second gates 115 and 116 may be electrically connected to each other, and thus the first and second gates 115 and 116 may be substantially equipotential. In one embodiment, the first and second gates 115 and 116 may be in contact with each other. In an alternative embodiment, the first and second gates 115 and 116 may be spaced apart from each other. In such an embodiment, the first and second gates 115 and 116 may be electrically connected to each other via a connector (not shown) or may receive a substantially same voltage as each other such that the first and second gates 115 and 116 may be substantially equipotential.

The first gate 115 includes the mesh portion 115a that is disposed on the first support portions 113a of the gate insulating layer 113 and the extension portion 115b that is disposed on the second support portion 113b of the gate insulating layer 113 and extends from the mesh portion 115a. The mesh portion 115a is supported by the first support portions 113a and thus is effectively maintained at a predetermined position, e.g., effectively prevented from hanging down. As shown in FIG. 8, a grid interval d of the mesh portion 115a (e.g., a width of a grid in the mesh portion 115a) may be substantially equal to or less than a height h of the first support portions 113a. As described above, in such an embodiment, where the grid interval d of the mesh portion 115a is substantially equal to or less than the height h of the first support portions 113a, an electric field is generated substantially uniformly on surfaces of the electron emission sources 118, and thus electrons may be uniformly emitted from the electron emission sources 118. In such an embodiment, openings in the mesh portion 115a may be defined substantially uniformly in the mesh portion 115a, e.g., distances between adjacent openings may be substantially equal to each other.

The second gate 116 is disposed on the extension portion 115b of the first gate 115. A gate hole 116a, through which electrons pass, is defined in the second gate 116. In an embodiment, the gate hole 116a is provided on an upper portion of the mesh portion 115a of the first gate 115. In such an embodiment, one side opening of the gate hole 116a, e.g., a lower opening, contacts the mesh portion 115a. The gate hole 116a may be defined, e.g., formed, to be wider (e.g., to have an increasing cross-sectional area) toward an upper portion thereof. In an embodiment, the gate hole 116a may have a cross-section of a predetermined shape. In one embodiment, as shown in FIG. 3, the gate hole 116a may have a rectangular cross-section. In an alternative embodiment, the gate hole 116a may have a circular cross-section, or a cross-section of other various shapes. In such an embodiment, the openings defined in the mesh portion 115a may have a shape corresponding to the cross-sectional shape of the gate hole 116a, e.g., the circular cross-section.

Focusing electrodes 117 may be disposed on upper portions of the gate electrodes 114, e.g., on the second gate 116, and spaced apart from the gate electrodes 114. The focusing electrodes 117 focuses electrons emitted from the electron emission sources 118 onto the anode electrode 151 of the X-ray emission device 150 when voltages are applied between the cathode electrodes 112 and the gate electrodes 114. Focusing holes 117a, through which electrons pass, are defined, e.g., formed, in the focusing electrodes 117. In an embodiment, focusing insulating layers 119 for insulating the gate electrodes 114 and the focusing electrodes 117 may be further disposed therebetween. In such an embodiment, insulating holes 119a for connecting the gate hole 116a and the focusing holes 117a may be defined in the focusing insulating layers 119. In an alternative embodiment, the focusing insulating layers 117 may not be omitted, and the focusing electrodes 117 may be disposed to be spaced apart from the gate electrodes 114. In an alternative embodiment, additional focusing electrodes (not shown) may be further disposed on upper portions of the focusing electrodes 117.

In an embodiment, as described above, the mesh portion 115a of the first gate 115 are disposed on the first support portions 113a of the gate insulating layer 113, and the second gate 116, in which the gate hole 116a having a cross-sectional area increasing toward the upper portion thereof is defined, is disposed on the first gate 115. In such an embodiment, the first and second gates 115 and 116 are electrically connected to each other such that the first and second gates 115 and 116 become equipotential. In an embodiment, the focusing electrodes 117 for focusing electrons are disposed on the upper portion of the second gate 116. In such an embodiment, electrons, which are substantially uniformly emitted from the electron emission sources 118 by the first support portions 113a and the mesh portion 115a, may pass through the gate hole 116a having a cross-sectional area increasing toward the upper portion thereof, may be focused by the focusing electrodes 117, and may form a focal spot having a very small diameter, for example, a diameter equal to or less than several hundreds micrometers (pm), on the anode electrode 151. Accordingly, in such an embodiment, an X-ray emitted from the anode electrode 151 may be used to obtain a high resolution image may be.

In an embodiment, as described above, the X-ray imaging system includes the flat panel type X-ray generator 100 including the plurality of X-ray generation units 100a that are two-dimensionally arranged and operate independently of each other. Thus, in such an embodiment, the object W disposed between the flat panel type X-ray generator 100 and the X-ray detector 200, e.g., a space defined between the flat panel type X-ray generator 100 and the X-ray detector 200 may have a substantially small thickness, thereby implementing the X-ray imaging system having a substantially small thickness. In one embodiment, for example, the X-ray imaging system may have a thickness of about 20 centimeters (cm). In the emission electron device 110 included in the X-ray generator 100, electrons may be substantially uniformly emitted from the electron emission sources 118 by the first support portions 113a and the mesh portion 115a, pass through the gate hole 116a having a cross-sectional area increasing toward the upper portion thereof, and be focused by the focusing electrodes 117. Thus, in such an embodiment, the focal spot having a substantially small diameter (e.g., a diameter equal to or less than several hundreds micrometers) may be formed on the anode electrode 151. As a result, the X-ray that may be used to obtain the high resolution image may be emitted from the anode electrode 151.

FIG. 10 shows an alternative embodiment of an X-ray emission device 150′ of FIG. 1. Referring to FIG. 10, an embodiment of the X-ray emission device 150′ includes an anode electrode 151′ and a shield window 152′ disposed in a lower surface of the anode electrode 151′. The anode electrode 151′ is an electrode that generates an X-ray by electrons emitted from an electron emission source. In one embodiment, for example, the anode electrode 151′ may include, for example, a metal such as W, Mo, Ag, Cr, Fe, Co, Cu, or a metal alloy thereof. The shield window 152′ shields the X-ray that is emitted from the anode electrode 151′ and travels in a direction other than a direction toward the corresponding X-ray detection unit 200a. In such an embodiment, a plurality of through holes 152′a having a cross-sectional area increasing in a direction to which the X-ray travels are defined in the shield window 152′.

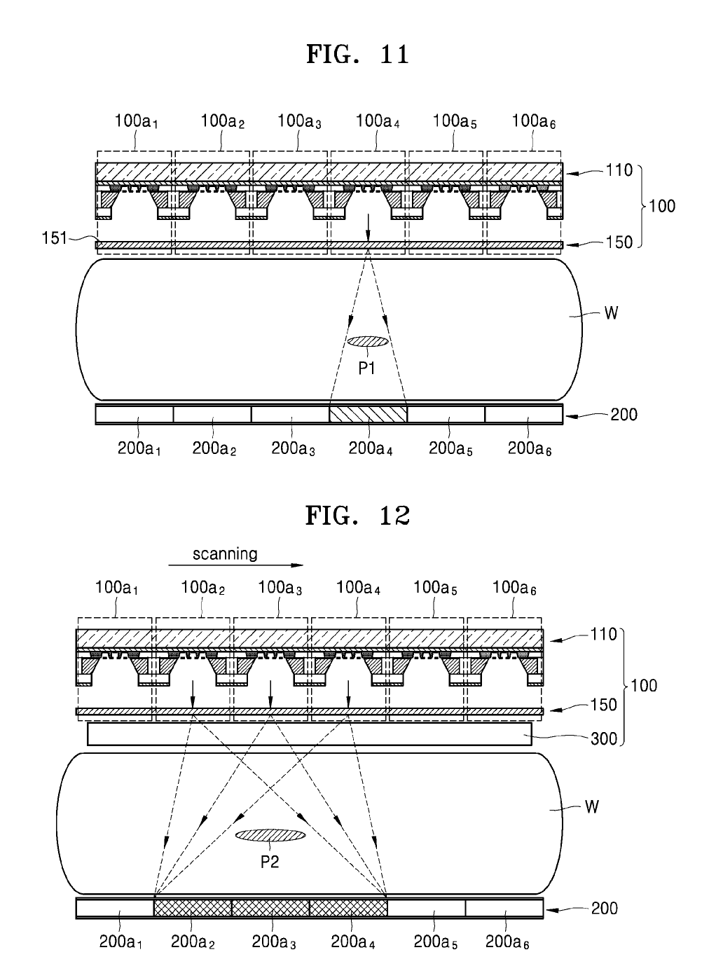

FIG. 11 is a view showing a method of photographing a specific region P1 of the object W using the X-ray imaging system of FIG. 1.

Referring to FIG. 11, among a plurality of X-ray generation units, e.g., a first X-ray generation unit 100a₁, a second X-ray generation unit 100a₂, a third X-ray generation unit 100a₃, a fourth X-ray generation unit 100a₄, a fifth X-ray generation unit 100a₅ and a sixth X-ray generation unit 100a₆, included in the X-ray generator 100, only a X-ray generation unit corresponding to the specific region P1 of the object to be photographed, e.g., the fourth X-ray generation unit 100a₄, is driven to emit an X-ray. The emitted X-ray passes through the specific region P1 of the object W and is detected by an X-ray detection unit 200a₄ corresponding to the fourth X-ray generation unit 100a₄. In such an embodiment, among a plurality of X-ray detection units, e.g., a first X-ray detection unit 200a₁, a second X-ray detection unit 200a₂, a third X-ray detection unit 200a₃, a fourth X-ray detection unit 200a₄, a fifth X-ray detection unit 200a₅ and a sixth X-ray detection unit 200a₆ included in the X-ray detector 200, only the fourth X-ray detection unit 200a₄ is driven. As described above, the X-ray imaging system drives a portion of the plurality of X-ray generation units 100a₁, 100a₂, 100a₃, 100a₄, 100a₅ and 100a₆ included in the X-ray generator 100, thereby efficiently photographing the specific region P1 of the object W. In an embodiment, as shown in FIG. 11, only one X-ray generation unit 100a₄ and a corresponding X-ray detection unit 200a₄ may be driven. However, in such an embodiment, two or more of the X-ray generation units 100aᵢ, 100a₂, 100a₃, 100a₄, 100a₅ and 100a₆ may be driven, and corresponding two or more of the X-ray detection units 200a₁, 200a₂, 200a₃, 200a₄, 200a₅ and 200a₆ may be driven. In an embodiment, a single X-ray generation unit corresponds to a single X-ray detection unit, as shown in FIG. 11, but not being limited thereto. In an alternative embodiment, a single X-ray generation unit may correspond to two or more X-ray detection units, or two or more X-ray generation units may correspond to a single X-ray detection unit.

FIG. 12 is a view showing a specific region P2 of the object W three-dimensionally photographed using the X-ray imaging system of FIG. 1.

Referring to FIG. 12, among the plurality of X-ray generation units 100a₁, 100a₂, 100a₃, 100a₄, 100a₅ and 100a₆ included in the X-ray generator 100, X-ray generation units, e.g., the second, third and fourth X-ray generation units 100a₂, 100a₃ and 100a₄, corresponding to the specific region P2 of the object W are driven. In such an embodiment, the second, third and fourth X-ray generation units 100a₂, 100a₃ and 100a₄ may be sequentially driven to emit an X-ray. In such an embodiment, the X-ray generator 100 may further include a collimator 300. In such an embodiment, the second X-ray generation unit 100a₂ is first driven to emit the X-ray. The emitted X-ray passes through the specific region P2 of the object W through the collimator 300, and then is detected by the corresponding X-ray detection units, e.g., the second, third and fourth X-ray detection units 200a₂, 200a₃, and 200a₄. In such an embodiment, the collimator 300 is disposed between the X-ray emission device 150 of the X-ray generator 100 and the object W to adjust the X-ray in a predetermined direction, and may include a portion having a predetermined shape, for example, a grid shape. In such an embodiment, as shown in FIG. 12, only a portion of the X-ray generation units, e.g., the second, third and fourth X-ray generation units 100a₂, 100a₃ and 100a₄, and corresponding X-ray detection units, e.g., the second, third and fourth X-ray detection units 200a₂, 200a₃, and 200a₄, are driven.

After the second X-ray generation unit 100a₂ is first driven to emit the X-ray, the third X-ray generation unit 100a₃ may be driven to emit an X-ray, and thus the X-ray passes through the specific region P2 of the object W through the collimator 300 and then is detected by the corresponding X-ray detection units 200a₂, 200a₃, and 200a₄. Thereafter, the fourth X-ray generation unit 100a₄ is driven to emit an X-ray, and thus the X-ray passes through the specific region P2 of the object W through the collimator 300 and then is detected by the corresponding X-ray detection units 200a₂, 200a₃ and 200a₄. Only the second, third and fourth X-ray detection units 200a₂, 200a₃ and 200a₄ may be driven among the X-ray detection units 200aᵢ, 200a₂, 200a₃, 200a₄, 200a₅ and 200a₆. In such an embodiment, the X-ray emitted from the X-ray generation units 100a₂, 100a₃ and 100a₄ that are sequentially driven may be used to obtain image data of the specific region P2 of the object W photographed in different directions through the X-ray detection units 200a₂, 200a₃ and 200a₄. Thus, a three-dimensional image of the specific region P2 of the object W may be obtained.

FIG. 13 shows an alternative embodiment of an X-ray imaging system according to the invention. The X-ray imaging system in FIG. 13 is substantially the same as the X-ray imaging system shown in FIGS. 11 and 12 except for the X-ray detector 200. The same or like elements shown in FIG. 7 have been labeled with the same reference characters as used above to describe the embodiments of the X-ray imaging system shown in FIGS. 11 and 12, and any repetitive detailed description thereof will hereinafter be omitted or simplified.

Referring to FIG. 13, the X-ray imaging system includes the X-ray detector (e.g., the flat panel type X-ray detector) 100 and an X-ray detector 200′ that detects an X-ray generated from the X-ray generator 100. In such an embodiment, the X-ray generator 100 may further include the collimator 300 which adjusts a traveling direction of the X-ray and is disposed between the X-ray emission device 150 of the X-ray generator 100 and the object W. The flat panel type X-ray generator 100, as described above, includes the plurality of X-ray generation units 100a₁, 100a₂, 100a₃, 100a₄, 100a₅ and 100a₆ that are two-dimensionally arranged and driven independently of each other. The X-ray detector 200′ includes the X-ray detection units 200aᵢ, 200a₂, 200a₃, 200a₄, 200a₅ and 200a₆ corresponding to the plurality of X-ray generation units 100a₁, 100a₂, 100a₃, 100a₄, 100a₅ and 100a₆. In such an embodiment, for example, a portion of the X-ray generation units, e.g., the second, third and fourth X-ray generation units 100a₂, 100a₃ and 100a₄, are driven to emit the X-ray, the X-ray passes through a specific region P3 of the object W through the collimator 300 and then is detected by the corresponding X-ray detection units, e.g., the second, third and fourth X-ray detection units 200a₂, 200a₃ and 200a₄. In such an embodiment, an area of each of the X-ray detection units 200a₂, 200a₃ and 200a₄ is smaller than an area of each of the X-ray generation units 100a₂, 100a₃, and 100a₄, thereby substantially reducing noise generated due to scattering.

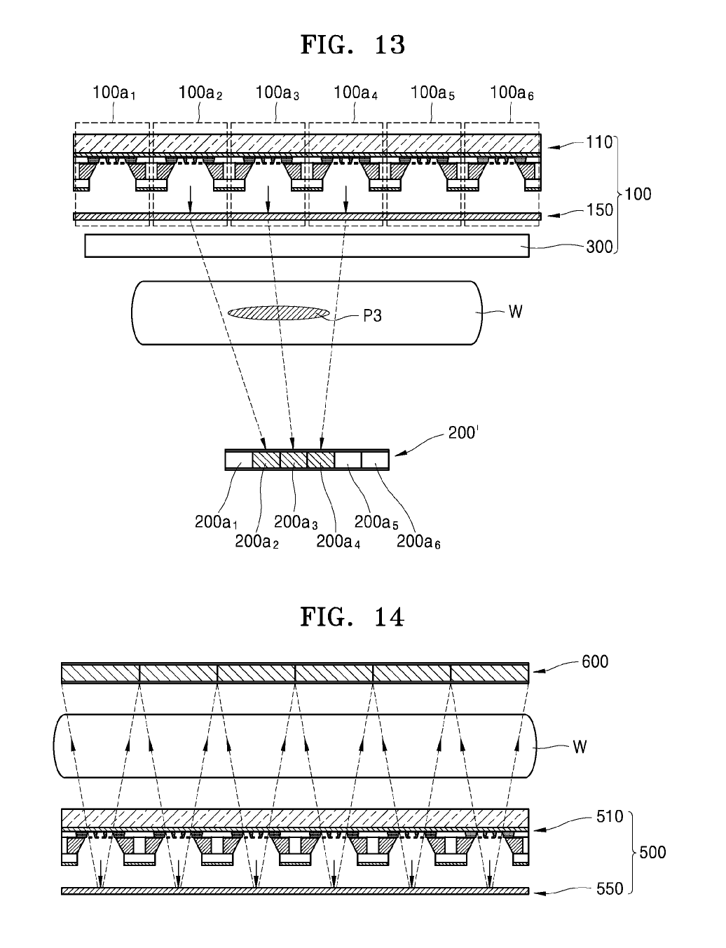

FIG. 14 shows another alternative embodiment of an X-ray imaging system. In an embodiment, as shown in FIG. 14, the X-ray imaging system may be a reflective type X-ray imaging system. The same or like elements shown in FIG. 14 have been labeled with the same reference characters as used above to describe the embodiments of the X-ray imaging system shown in FIGS. 11 to 13, and any repetitive detailed description thereof will hereinafter be omitted or simplified.

Referring to FIG. 14, the X-ray imaging system includes a flat panel type X-ray generator 500 and an X-ray detector 600 that detects an X-ray generated from the X-ray generator 500. The flat panel type X-ray generator 500, as described above, includes a plurality of X-ray generation units that may be two-dimensionally arranged and driven independently of each other. The X-ray generation units includes a plurality of electron emission units that are two-dimensionally arranged and emit electrons independently of each other and a plurality of X-ray emission units that emit the X-ray by the electrons emitted from the electron emission units. In such an embodiment, the plurality of electron emission units collectively defines an electron emission device, and the plurality of X-ray emission units collectively defines an X-ray emission device. Thus, the X-ray generator may include an electron emission device 510 including the plurality of electron emission units and an X-ray emission device 550 including the plurality of X-ray emission units. In such an embodiment, where the X-ray imaging system may be a reflective X-ray imaging system, the X-ray emission device 550 may reflect the X-ray. In such a reflective X-ray imaging system, the X-ray detector 600 is disposed on an upper portion of the X-ray emission device 510, and the object W is disposed between the X-ray emission device 510 and the X-ray detector 600. Thus, the X-ray reflected from the X-ray emission device 550 passes through the object W through the electron emission device 510 and then reaches the X-ray detector 600. In such an embodiment, the object W may be disposed or defined to contact at least one of the electron emission device 510 and the X-ray detector 600. In such an embodiment, the X-ray generator 500 may further include a collimator which adjusts a traveling direction of the X-ray and is disposed between the object W and the electron emission device 510.

According to embodiments of the invention as described herein, the X-ray imaging system includes a flat panel type X-ray generator including a plurality of X-ray generation units that are two-dimensionally arranged and driven independently of each other. In such an embodiment, an object or a space having a small thickness is disposed or defined between the flat panel type X-ray generator and the X-ray detector, thereby implementing the X-ray imaging system having a substantially small thickness. In such an embodiment, only a portion of the plurality of generation units corresponding to a specific or predetermined region of the object may be driven, thereby efficiently photographing the specific region of the object, and such selectively partial photographing effectively prevents an irradiation of an X-ray to a region other than a predetermined region, thereby substantially reducing an exposure rate. In such an embodiment, a portion of the plurality of generation units may be sequentially driven, thereby effectively performs a three-dimensional photographing of the specific region of the object. In an electron emission device in the X-ray generator, electrons may be substantially uniformly emitted from electron emission sources by first support portions and a mesh portion, pass through a gate hole having a cross-sectional area increasing toward an upper portion thereof, and be focused by a focusing electrode. Thus, a focal spot having a substantially small diameter (e.g., a diameter equal to or less than several hundreds micrometers) may be formed on an anode electrode. As a result, an X-ray that may be used to obtain a high resolution image may be emitted from the anode electrode. Therefore, the X-ray imaging system may substantially reduce the exposure rate with respect to the object, diverse system configurations corresponding to diverse sizes of the object may be achieved, and a substantially uniform and high resolution X-ray image may be implemented.

While the general invention has been particularly shown and described with reference to exemplary embodiments thereof, it will be understood by those of ordinary skill in the art that various changes in form and details may be made therein without departing from the spirit and scope of the general invention as defined by the following claims.

What is claimed is:

1. An X-ray imaging system comprising:
an X-ray generator comprising a plurality of X-ray generation units, wherein the plurality of X-ray generation units is two-dimensionally arranged, and operates independently of each other; and
an X-ray detector spaced apart from the X-ray generator, wherein the X-ray detector comprises a plurality of X-ray detection units corresponding to the plurality of X-ray generation units, wherein a space is defined between the X-ray generator and the X-ray detector.

2. The X-ray imaging system of claim 1, wherein the space between the X-ray generator and the X-ray detector is defined by at least one of the X-ray generator and the X-ray detector.

3. The X-ray imaging system of claim 1, wherein an X-ray generated from a portion of the plurality of X-ray generation units is irradiated into a specific region of the space between the X-ray generator and the X-ray detector.

4. The X-ray imaging system of claim 3, wherein
when the X-ray is irradiated into the specific region of the space, a portion of the plurality of X-ray detection units corresponding to the portion of the plurality of X-ray generation units is driven.

5. The X-ray imaging system of claim 3, wherein the portion of the plurality of X-ray generation units is simultaneously or sequentially driven.

6. The X-ray imaging system of claim 1, wherein an area of the plurality of X-ray generation units is substantially equal to or greater than an area of the plurality of X-ray detection units.

7. The X-ray imaging system of claim 1, wherein
the X-ray generator further comprises a collimator disposed between the X-ray generation units and the X-ray detector,
wherein the collimator adjusts a direction of an X-ray generated from the X-ray generation units.

8. The X-ray imaging system of claim 1, wherein the plurality of X-ray generation units comprises:
a plurality of electron emission units which emits a plurality of electrons; and
a plurality of X-ray emission units which emits an X-ray by the electrons emitted from the plurality of electron emission units.

9. The X-ray imaging system of claim 8, wherein the X-ray generator further comprises:
an electron emission device comprising the plurality of electron emission units; and
an X-ray emission device comprising the plurality of X-ray emission units.

10. The X-ray imaging system of claim 8, wherein each of the plurality of electron emission units comprises:
a cathode electrode;
a gate electrode spaced apart from the cathode electrode, wherein the gate electrode comprises:
a first gate comprising a mesh portion, and an extension portion disposed around the mesh portion; and
a second gate disposed on the extension portion of the first gate, wherein a gate hole, which exposes the mesh portion, is defined in the second gate;
a gate insulating layer disposed between the cathode electrode and the gate electrode, wherein the gate insulating layer comprises:
a plurality of first support portions which supports the mesh portion; and
a second support portion which supports the extension portion; and
a plurality of electron emission sources disposed on a portion of the cathode electrode exposed by the gate insulating layer.

11. The X-ray imaging system of claim 10, wherein the gate hole has a cross-sectional area decreasing toward the first gate.

12. The X-ray imaging system of claim 11, further comprising:
a focusing electrode disposed on the gate electrode and spaced part from the gate electrode.

13. The X-ray imaging system of claim 11, wherein the first and second gates are electrically connected to each other.

14. The X-ray imaging system of claim 11, wherein a grid interval of the mesh portion is substantially equal to or less than a height of the plurality of first support portions.

15. The X-ray imaging system of claim 10, wherein
the plurality of first support portions is disposed on the cathode electrode in a stripe shape, and
the plurality of electron emission sources is disposed between adjacent first support portions of the plurality of first support portions in the stripe shape or between the first and second support portions.

16. The X-ray imaging system of claim 10, wherein a height of the plurality of electron emission sources is lower than a height of the gate insulating layer.

17. The X-ray imaging system of claim 10, wherein the plurality of X-ray emission units comprises:
an anode electrode which generates the X-ray by the electrons emitted from the plurality of electron emission sources.

18. The X-ray imaging system of claim 17, wherein the plurality of X-ray emission units further comprise:
a shield window disposed on the anode electrode and which blocks the X-ray.

19. An X-ray generator comprising:
a plurality of X-ray generation units which is two-dimensionally arranged and operates independently of each other,
wherein the plurality of X-ray generation units comprises:
a plurality of electron emission units which emits electrons; and
a plurality of X-ray emission units which emit an X-ray by the electrons emitted from the plurality of electron emission units,
wherein each of the plurality of electron emission units comprises:
a cathode electrode;
a gate electrode spaced apart from the cathode electrode,
wherein the gate electrode comprises:
a first gate comprising a mesh portion and an extension portion disposed around the mesh portion; and
a second gate disposed on the extension portion of the first gate, wherein a gate hole, which exposes the mesh portion, is defined in the second gate;
a gate insulating layer disposed between the cathode electrode and the gate electrode, wherein the gate insulating layer comprises:
a plurality of first support portions which supports the mesh portion; and
a second support portion which supports the extension portion; and
a plurality of electron emission sources disposed on a portion of the cathode electrode exposed by the gate insulating layer.

20. The X-ray generator of claim 19, wherein the gate hole has a cross-sectional area decreasing toward the first gate.

21. The X-ray generator of claim 19, wherein the first and second gates are electrically connected to each other.

22. The X-ray generator of claim 19, wherein a grid interval of the mesh portion is substantially equal to or less than a height of the first support portions.

23. An electron emission device comprising:
a plurality of electron emission units which is two-dimensionally arranged and operates independently of each other,
wherein each of the plurality of electron emission units comprises:
a cathode electrode;
a gate electrode spaced apart from the cathode electrode, wherein the gate electrode comprises:
a first gate comprising a mesh portion, and an extension portion disposed around the mesh portion; and
a second gate disposed on the extension portion of the first gate, a gate hole, which exposes the mesh portion, is defined in the second gate;
a gate insulating layer disposed between the cathode electrode and the gate electrode, wherein the gate insulating layer comprises:
a plurality of first support portions which supports the mesh portion; and
a second support portion which supports the extension portion; and
a plurality of electron emission sources disposed on a portion of the cathode electrode exposed by the gate insulating layer.

24. The electron emission device of claim 23, wherein the gate hole has a cross-sectional area decreasing toward the first gate.

25. The electron emission device of claim 23, wherein the first and second gates are electrically connected to each other.

26. The electron emission device of claim 23, wherein a grid interval of the mesh portion is substantially equal to or less than a height of the first support portions.
